(19) United States
(12) Patent Application Publication
(10) Pub. No.: US 2022/0263385 A1
(43) Pub. Date: Aug. 18, 2022

(54) CORELESS MOTOR AND POWER GENERATOR

(71) Applicant: CORELESS MOTOR CO., LTD., Yamato-shi, Kanagawa (JP)

(72) Inventors: Manabu SHIRAKI, Yamato-shi, Kanagawa (JP); Kuniyuki TANAKA, Yamato-shi, Kanagawa (JP); Shotaro KAWANO, Yamato-shi, Kanagawa (JP)

(73) Assignee: CORELESS MOTOR CO., LTD., Yamato-shi, Kanagawa (JP)

(21) Appl. No.: 17/633,013

(22) PCT Filed: Dec. 23, 2019
(86) PCT No.: PCT/JP2019/050351

§ 371 Date: Feb. 4, 2022

(30) Foreign Application Priority Data
Aug. 8, 2019 (JP) PCT/JP2019/031502

(51) Int. Cl. H02K 9/20; H02K 5/20; H02K 7/116

(52) U.S. Cl. CPC H02K 9/20; H02K 7/116; H02K 5/203

(57) ABSTRACT

The coreless motor includes a rotation center shaft that extends in the axial direction at the center of a sealed housing, a cylindrical coil that is disposed with respect to the rotation center shaft in the housing, an end surface on one side of the cylindrical coil being supported by a stator and extending in the direction in which the rotation center shaft extends, a rotor that is disposed concentrically with respect to the rotation center shaft in the housing, and that rotates in the circumferential direction of the rotation center shaft, and a liquid refrigerant that is accommodated in the housing, that flows inside the housing due to the rotation of the rotor, and that contacts the cylindrical coil.

### BACKGROUND

For an electric motor, the limits within which the elements such as the coil, the magnet and the like that constitute the electric motor are allowed to be used when the temperatures of those elements are rising during their normal operation are generally presented as the respective ratings defined and offered by the electric motor manufacturer. Generally, those ratings are described as the own reference data guaranteed and recommended by the electric motor manufacturer in the catalog or in the element specification table when the electric motor is operated at the predetermined voltage and at the rated torque or at the rated power. For example, a maximum power output generated by the electric motor that provides its good characteristics when it is operated at the predetermined voltage is defined as the rated power output, the rotational speed when it is operated at the rated power output is defined as the rated rotational speed, the torque at that time is defined as the rated torque, and the electric current at that time is defined as the rated electric current.

Typically, one of the electric motors offered by the inventor of the present application to the commercial market comprises a cylindrical coil which is disposed concentrically with respect to a rotation center shaft in a housing and extends in the direction in which the rotation center shaft extends and an end surface on one side of the cylindrical coil is supported by a stator, and a rotor which is disposed concentrically with respect to the rotation center shaft in the housing and capable of rotation in the circumferential direction of the rotation center shaft.

The ratings of this coreless motor were definded under the condition in which the temperature of the cylindrical coil did not exceed the allowable upper limit temperature of 130° C., such as the rated torque To=0.28 Nm, the rated electric current Io=9.7Arms, the rated rotational speed No=6537 rpm and the rated output Po=191.67W.

When this coreless motor was used so that it is driven under the conditions exceeding the ratings of the coreless motor, it was discovered that the allowable upper limit temperature of the cylindrical coil exceeded the temperature of 130° C. in a few tens of seconds after the driving of the motor was started: The worst situation that can be assumed easily from the above discovery is that the cylindrical coil will burn and break down when the motor is driven under the condition exceeding the ratings of the motor. Even if such break-down situation does not occur, the long time period normal operation of the motor can not be expected from the viewpoint of its performance.

As described above, the electric motor might momentarily exceed the rated electric current when the motor is started or otherwise, but usually it is not assumed that the electric motor is continuously operated in the state in which the motor exceeds the rated electric current. When the electric motor is continuously operated under its overloaded condition, that is, under the rated condition or over the rated condition, the electric current may cause the coil of the electric motor to be heated above the assumed heating level.

In view of the above description, the inventor of the present application has proposed a coreless motor that includes a cooler in addition to the cylindrical coil that has been provided in the coreless motor. According to the coreless motor that includes a cooler, it can prevent degradation of motor performance due to heat generation in the cylindrical coil and heating of the magnet, and the motor can be operated at a load in excess of its rating (see Patent Documents 1 and 2).

Various proposals have been made to permit the electric motor to include an additional cooling function (for example, see Patent Documents 3, 4, 5 and 6). Prior Art Reference Patent Document
Patent Document 1: JP5943333B
Patent Document 2: JP6399721B
Patent Document 3: JP 1992-359653 A
Patent Document 4: JP 2018-157645A
Patent Document 5: JP 2014-90553A
Patent Document 6: US Patent Application Publication No. US2014/0175917

### SUMMARY OF THE INVENTION

One object of the present invention is to provide a coreless motor and a power generator in which the coreless motor has s simple structure and is capable of suppressing the overheating of the cylindrical coil that may be caused to occur during the motor operation and is also capable of producing a high power output, and the power generator has the structures and capabilities equivalent to those of the coreless motor.

In the coreless motor which comprises a rotation center shaft, a cylindrical coil disposed concentrically with respect to the rotation center shaft and extending in the direction in which the rotation center shaft extends, and a rotor disposed concentrically with respect to the rotation center shaft and capable of rotating in the circumferential direction, the rotor including a cylindrical inner yoke and a cylindrical outer yoke between which the cylindrical coil is sandwiched in the radial direction and having a magnet provided on the outer side of the inner yoke or on the inner side of the outer yoke, the particular object of the present invention is to provide a coreless motor that is capable of suppressing the overheating of the coil that may be caused to occur during the motor operation and is capable of producing a high power output and a power generator having the structures and capabilities that are equivalent to those of the coreless motor.

Means for Solving the Problem that has been Mentioned Above

The problem that has been mentioned above may be solved by providing a coreless motor and a power generator, both of which will be described in detail below. In its specific form, the coreless motor may be structured such that it comprises a rotation center shaft extending in the axial direction thereof at the center of a sealed housing, a cylindrical coil disposed concentrically with respect to the rotation center shaft in the housing with an end surface on one side of the cylindrical coil being supported by a stator and extending in the direction in which the rotation center shaft extends, and a rotor disposed concentrically with respect to the rotation center shaft in the housing and capable of rotation in the circumferential direction of the rotation center shaft, the rotor including a cylindrical inner yoke and a cylindrical outer yoke between which the cylindrical coil is sandwiched in the radial direction and a magnet provided on the outer side of the inner yoke or on the inner side of the outer yoke, and in its specific form, the power generator has the structures and capabilities that are equivalent to those of the coreless motor.

The coreless motor further includes a liquid refrigerant that is contained in the housing and is structured such that it has its liquid surface extending in the axial direction thereof in its stationary state and contacting the outer side of the outer yoke. The liquid refrigerant may be allowed to flow within the housing by the rotation of the rotor and contact the cylindrical coil.

A space having the form of a doughnut in cross section is formed between the inner yoke and the outer yoke between which the cylindrical coil is sandwiched in the radial direction and the liquid refrigerant is allowed to flow into the housing by the rotation of the rotor, contacting the cylindrical coil that generates the heat and removing the heat from the cylindrical coil. The heating thus removed from the cylindrical coil is then carried by the liquid refrigerant flowing in the housing into the housing and is dissipated from the entire outer circumferential surface of the housing having its surface area larger than the cylindrical coil.

This allows the liquid refrigerant to cool the cylindrical coil that generates the heat by driving the rotor to rotate and the heating thus generated from the cylindrical coil is then removed by the liquid refrigerant that conducts the heating thus removed to the housing by flowing in the housing. The heating is then dissipated from the entire outer circumferential surface of the housing. This allows the overheating of the cylindrical coil that may be caused to occur during the operation of the coreless motor to be suppressed and actuates the coreless motor to rotate at high speeds and provide the high power output by allowing the excessive electric current to be supplied to the cylindrical coil.

In addition, the rotor that is driven to rotate at high speeds causes the liquid refrigerant to flow through the housing at high speeds so that the liquid refrigerant can be finely divided into fine particles. This allows the liquid refrigerant in its atomized state to flow at high speeds in the housing. In addition, this allows part of the flowing liquid refrigerant to contact the cylindrical coil being heated and vaporize. As a result, the temperature of the housing can be raised efficiently up to the temperature that is almost equal to the temperature of the cylindrical coil being heated. And the heating whose temperature has thus been raised can be dissipated from the entire outer circumferential surface of the housing. This allows the overheating of the cylindrical coil that may be caused to occur during the operation of the coreless motor to be suppressed and permits the coreless motor to rotate at high speeds and produce the high power output by supplying the excessive electric current to the coil.

[1]

A coreless motor which comprises:

a rotation center shaft extending in the axial direction thereof at the center of a sealed housing;

a cylindrical coil disposed concentrically with respect to said rotation center shaft in said housing with an end surface on one side of said cylindrical coil being supported by a stator and extending in the direction in which said rotation center shaft extends;

a rotor disposed concentrically with respect to said rotation center shaft and capable of rotation in the circumferential direction of said rotation center shaft, said rotor including a cylindrical inner yoke and a cylindrical outer yoke sandwiching said cylindrical coil therebetween in the radial direction and having a magnet provided on the outer side of said inner yoke or on the inner side of said outer yoke; and

a liquid refrigerant contained in said housing, said liquid refrigerant having its liquid surface extending in said axial direction in its stationary state and contacting the outer circumferential side of said outer yoke, whereby said liquid refrigerant is caused by the rotation of said rotor to flow inside said housing and contact said cylindrical coil.

[2]

The coreless motor according to [1], wherein said outer yoke has a hole passing through said outer yoke in the radial direction thereof.

[3]

A coreless motor which comprises:

a rotation center shaft extending in the axial direction thereof at the center of a sealed housing;

a cylindrical coil disposed concentrically with respect to said rotation center shaft in said housing with an end surface on one side of said cylindrical coil being supported by a stator and extending in the direction in which said rotation center shaft extends;

a rotor disposed concentrically with respect to said rotation center shaft and capable of rotation in the circumferential direction of said rotation center shaft, said rotor including a cylindrical inner yoke and a cylindrical outer yoke sandwiching said cylindrical coil therebetween in the radial direction and having a magnet provided on the outer side of said inner yoke or on the inner side of said outer yoke;

a speed reduction gear disposed in said housing and including planetary gears for transmitting the rotational movement of said rotor around said rotation center shaft to a rotational movement output section from which a different rotational movement is produced; and

a liquid refrigerant contained in said housing, said liquid refrigerant having its liquid surface extending in said axial direction in its non-rotational state and contacting the outer circumferential side of said outer yoke, whereby said liquid refrigerant is caused by the rotation of said rotor to flow inside said housing and contact said cylindrical coil.

[4]

The coreless motor according to [3], wherein said speed reduction gear is contained in a cylindrical gear case extending in the direction in which said rotation center shaft extends, said gear case having a hole passing through said gear case in the radial direction.

[5]

The coreless motor according to [3] or [4], wherein the liquid surface of said liquid refrigerant extending in said axial direction in its stationary state contacts the outermost circumferential edge of said planetary gears in the radial direction thereof.

[6]

A power generator having the structures and capabilities that are equivalent to those of the coreless motor according to the before described [1] to [5].

According to the present invention, it is possible to provide a coreless motor having a simple structure in which the overheating of a coil that may be caused to occur during the operation of a motor is suppressed and an excessive electric current is supplied to the coil to permit the motor to rotate at high speeds and produce a high power output. It is also possible to provide a power generator having the equivalent structure and capabilities of the coreless motor.

### BRIEF DESCRIPTION OF DRAWINGS

FIG. 1 is an enlarged cross sectional view illustrating the internal structure of a coreless motor in accordance with one embodiment of the present invention although some parts or elements are not shown;

FIG. 2 is an enlarged cross sectional view illustrating the internal structure of the coreless motor in the embodiment shown in FIG. 1 in accordance with another embodiment of the present invention although some parts or elements are not shown;

FIG. 3 is a conceptual diagram illustrating a liquid refrigerant stirring means in another embodiment of the coreless motor in the embodiment shown in FIG. 1 in accordance with one embodiment of the present invention.

FIG. 4 is an enlarged cross sectional view illustrating the internal structure of the coreless motor in accordance with another embodiment of the present invention although some parts or elements are not shown;

FIG. 5 is an enlarged cross sectional view illustrating the internal structure of the coreless motor in the embodiment shown in FIG. 4 in accordance with another embodiment of the present invention although some parts or elements are not shown;

FIG. 6 is a side view illustrating a cylindrical gear case employed in the embodiment shown in FIG. 5;

FIG. 7 is a perspective view illustrating a cylindrical gear case employed in the embodiment shown in 5;

FIG. 8 is a perspective view illustrating other embodiments of the coreless motor in the embodiment shown in FIG. 4;

FIG. 9 is a perspective view illustrating the internal structure of the coreless motor shown and partially broken away in FIG. 8 although some parts or elements are not shown;

FIG. 10 is a cross sectional view illustrating the internal structure of the coreless motor shown in FIG. 8 although some parts or elements are not shown;

FIG. 11 (a) is a cross sectional view illustrating the height position of the liquid surface of the liquid refrigerant contained in the housing in its stationary state according to the embodiments in FIGS. 1 and 2 although some parts or elements or elements are not shown, and (b) is a cross sectional view illustrating the state in which the height position of the liquid surface of the liquid refrigerant in its stationary state is greater than the height position of the liquid surface shown in FIG. 11 (a); and

FIG. 12 is a cross sectional view illustrating one example of the height position of the liquid surface of the liquid refrigerant contained in the housing of embodiment shown in FIG. 4 in its non-rotational state although some parts or elements are not shown.

### BEST MODE OF EMBODYING THE INVENTION

### Embodiment 1

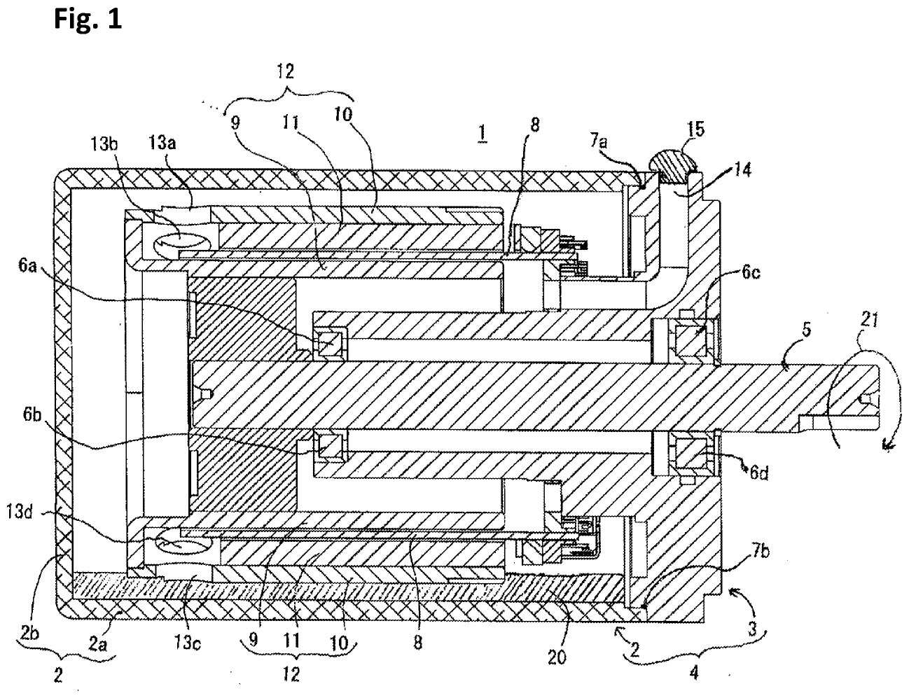

The coreless motor 1 shown in FIG. 1 includes a sealed housing 4 and a cylindrical center shaft 5 extending in the axial direction thereof at the center of the housing 4 (in the right to left direction in FIG. 1).

In the embodiment shown in FIG. 1, the rotation center shaft 5 is rotatably supported in the housing 4, and the rotation center shaft 5 serves as the means for actuating the coreless motor 1 to rotate at high speeds and produce a high power output.

In the illustrated embodiment, the sealed housing 4 is composed of a cylindrical casing 2 and a disk-shaped lid 3 which closes the right end opening of the cylindrical casing 2 in FIG. 1.

The cylindrical casing 2 includes a disk-like portion 2b and a cylindrical portion 2a. A right end portion of the cylindrical portion 2 included in the cylindrical casing 2 in FIG. 1 is pressed to the disk-like lid portion 3 by means of pickings 7a and 7b. The rotation center shaft 5 is rotatably supported in the housing on the radially inner side of the cover 3 by means of a bearing 6a, 6b, 6c, 6d with a seal. Typically, the bearing 6a etc with the seal may be a bearing with oil seal. In the specification, the bearing 6a, 6b, 6c, 6d with the oil seal may be referred simply as a bearing 6a, 6b, 6c, 6d.

In the illustrated embodiment, the housing 4 is hermetically sealed by the presence of the pickings 7a, 7b and the bearing 6a, 6b, 6c, 6d.

The coreless motor 1 further includes a cylindrical coil 8 and a rotor 12 both of which are provided inside the housing 4.

The cylindrical coil 8 is disposed concentrically with respect to the rotation center shaft 5, and the end surface on one side of the cylindrical coil 8 (the right end surface in the embodiment in FIG. 1) is supported by the stator which is also supported in the housing 4 and extends in the direction in which the rotation center shaft extends.

The cylindrical coil 8 may be a coreless coil through which the electric current can be conducted. In the illustrated embodiment, it is shown in FIG. 1 that the cylindrical coil 8 is formed like the cylindrical shape by the laminated structure of a electrically conductive metal sheet formed by superposing a plurality of spaced linear portions and an insulating layer through the insulating layer in a longitudinal direction corresponding to the direction in which the rotation center shaft extends. The thickness in the radial direction is, for example, 5 mm or less and has a predetermined rigidity. The cylindrical coil like the one shown in FIG. 1 may be obtained by the manufacturing method described in JP 3704044, for example.

The rotor 12 is disposed concentrically with respect of the rotation center shaft 5 and is supported by the rotation center shaft 5 on the center side thereof in the radial direction. In the embodiment shown in FIG. 1, the rotor 12 includes an inner yoke 9 and an outer yoke 10 between which the cylindrical coil 8 is sandwiched in the radial direction. The outer yoke 10 has a magnet 11 on the radially inner side surface facing the inner yoke 9. This creates a magnet field formed like the doughnut shape in cross section between the inner yoke 9 and the outer yoke 10 that has the magnet 11 on the radially inner side surface between which the cylindrical coil 8 is sandwiched. A magnet circuit is thus formed.

In the embodiment shown in FIG. 1, the magnet 11 is provided on the radially inner side surface of the outer yoke 10, but it may also be provided on the radially outer side surface of the inner yoke 9.

A liquid refrigerant 20 is contained in the sealed housing 4. In the embodiment shown in FIG. 1, the disk-shaped lid 3 of the housing 4 has an opening 14 which is sealed by a plug 15.

After the plug 15 is removed from the opening 14 to allow a predetermined amount of the liquid refrigerant 20 to flow into the housing and then the opening 14 is again closed by the plug 15, the housing 4 will be kept in its sealed condition.

The liquid refrigerant 20 may be replaced by the oil used for lubricating the mechanical operating parts, the antifreeze water and the like.

In the coreless motor 1 shown in FIG. 1, as a predetermined electric current is supplied to the cylindrical coil 8 while the magnet field formed like the doughnut shape in cross section is created between the inner yoke 9 and the outer yoke 10, the rotor 12 will be driven to rotate in the circumferential direction of the rotation center shaft 5. The radially inner side of the inner yoke 9 included in the rotor 12 is supported by the rotation center shaft 5, which means that the rotation center shaft 5 is also driven to rotate in the circumferential direction as indicated by an arrow 21 in FIG. 1.

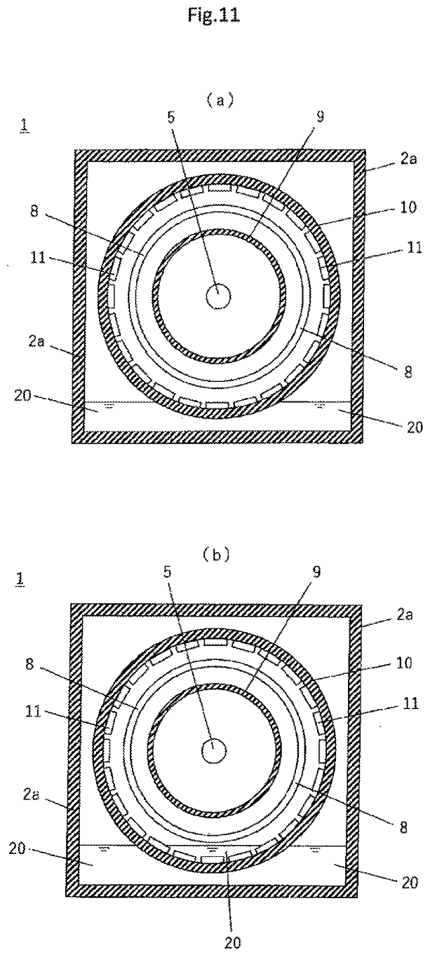

As shown in FIG. 1 and FIG. 11 (a), the liquid refrigerant 20 contained in the housing 4 is structured such that it allows the liquid surface extending in the axial direction in its stationary state to contact the outer circumferential side surface of the outer yoke 10.

As the rotor 20 is driven to rotate in the circumferential direction of the rotation center shaft 5, the liquid refrigerant 20 that is in contact with the outer circumferential surface of the outer yoke 10 is activated to flow along the outer circumferential surface of the outer yoke 10 in the circumferential direction in which the outer yoke 10 rotates, causing its liquid surface to rise in the circumferential direction along the outer circumferential surface of the outer yoke 10. After then, the liquid refrigerant 20 whose liquid surface has risen in the circumferential direction on the outer circumferential surface of the outer yoke 10 fall down by its own weight to the bottom surface side of the housing 4 in the horizontal state shown in FIG. 1 along the outer circumferential side surface of the outer yoke 10. With the liquid refrigerant 20 repeating its flow movement caused by the rotation of the rotor 12, part of the liquid refrigerant 20 flows into the space from the right and left end portions shown in FIG. 1, the space being formed like the doughnut shape in cross section and being formed between the inner yoke 9 and the outer yoke 10 between which the cylindrical coil 8 is sandwiched in the radial direction. The liquid refrigerant 20 that has thus flowed into the space makes contact with the cylindrical coil 8 whose temperature is beginning to increase during the operation.

By allowing part of the liquid refrigerant 20 to contact the cylindrical coil 8 being heated, the cylindrical coil 8 is cooled. Furthermore, by allowing the liquid refrigerant 20 that has removed the heat from the cylindrical coil 8 being heated to flow in the housing 4, the heat thus removed is conducted to the housing 4 through the liquid refrigerant 20, causing the temperature of the housing 4 to rise and allowing the heat to be dissipated from the entire outer circumferential surface of the housing 4. In this way, the overheating of the cylindrical coil 8 that may be caused to occur during the operation of the coreless motor 1 is suppressed, and the excessive electric current is supplied to the coil so that the coreless motor 1 can rotate at high speeds and produce a high power output.

In the coreless motor that is structured such that it comprises the rotation center shaft 5 extending in the axial direction thereof at the center of the sealed housing 4, the cylindrical coil 8 disposed fixedly and concentrically with respect to the rotation center shaft 5 in the housing 4 and extending in the direction in which the rotation center shaft 5 extends, and the rotor 12 that is disposed concentrically with respect to the rotation center shaft 5 and is capable of rotating in the circumferential direction of the rotation center shaft 5, said rotor 12 including the cylindrical inner yoke 9 and the cylindrical outer yoke 10 between which the cylindrical coil 8 is sandwiched in the radial direction and having the magnet 11 provided on the outer side of the inner yoke 9 or on the inner side of the outer yoke 10, the coreless motor further includes the liquid refrigerant 20 that is contained in the housing 4 and has its liquid surface extending in the axial direction in its non-rotational state that is structured such that it makes contact with the outer circumferential side surface of the outer yoke 10 and then makes contact with the cylindrical coil 8 by driving the rotor 12 to rotate in order to allow the liquid refrigerant 20 to flow in the housing 4. This can suppress the overheating of the coil that may be caused to occur during the operation of the motor.

In the conventional cooling mechanism for the electric motor as proposed in Patent Document 3 to 6, the structure that has been described above in connection with the coreless motor described in the embodiments of the present invention and in which the liquid refrigerant is actuated by the rotation of the rotor 12 to flow into the space formed like the doughnut shape in cross section, the space being formed between the inner yoke and the outer yoke between which the cylindrical coil 8 is sandwiched in the radial direction, the liquid refrigerant may be made to contact the cylindrical coil 8 being heated and the heating of the cylindrical coil 8 may be removed from the cylindrical coil 8 is not proposed.

It is apparent from the embodiment described above that the liquid refrigerant 20 contained in the sealed housing 4 is finely divided into the fine particles by driving the rotor 12 to rotate at high speeds in the circumferential direction of the rotation center shaft 5, enabling the liquid refrigerant 20 to flow into the housing 4 at high speeds. The liquid refrigerant 20 in its sprayed state flowing at high speeds in the housing 4 enters the gap formed like the doughnut shape in cross section between the radially inner side of the magnet 11 and the radially outer side of the cylindrical coil 8 and then enters the gap formed like the doughnut shape in cross section between the radially outer side of the inner yoke 9 and the radially inner side of the cylindrical coil 8.

The cylindrical coil 8 to which the electric current is supplied generates the heat, and part of the liquid refrigerant 20 in its sprayed state that makes contact with the radially inner side and radially outer side of the cylindrical coil 8 is vaporized by the cylindrical coil 8 being heated at the high temperature.

As a result, the internal space of the housing 4 is finely divided into fine particles by the rotor 12 which is driven to rotate at high speeds and is then brought into the gas-liquid mixed condition in which the liquid refrigerant 20 in its sprayed state exists. Then, the rotor 12 is driven to rotate at high speeds in the sealed atmosphere which is placed in the gas-liquid mixed condition. By causing the rotor 12 rotating at high speeds to enable any substances in their sprayed state that may be contained in the gas-liquid mixture to flow in the sealed housing 4. The heat conduction that occurs from the cylindrical coil 8 being heated by the conducted current to the housing 4 is thus improved as compared with the condition in which only the gas exists.

This causes the electric current to begin to conduct through the cylindrical coil 8, driving the rotor 12 to rotate. As the temperature of the cylindrical coil 8 begins to rise, the temperature of the disk-shaped portion 2b and cylindrical portion 2a included in the housing 4 is also beginning to increase. The temperature of the disk shaped portion 2b and cylindrical portion 2a is then gradually brought closer to the temperature of the cylindrical coil 8 being heated. In this manner, the heat is dissipated for the wider heat dissipating area, that is, the outer side surface of the disk-shaped portion 2b and cylindrical portion 2a.

The result thus obtained is that the overheating the cylindrical coil 8 that may be caused to occur during the rotation of the coreless motor 1 can be suppressed and enables the coreless motor 1 to rotate at high speeds and provide the high power output by supplying the excessive electric current to the cylindrical coil 8.

In the embodiment shown in FIG. 1, the liquid refrigerant 20 contained in the sealed housing 4 is stored in the housing 4 as it makes contact with a part of the rotor 12. As the rotor 12 is then driven to rotate, it causes the liquid refrigerant 20 to start to flow in the housing 4 immediately.

Although it is not shown, it is also possible to provide the embodiment in which the liquid refrigerant 20 contained in the housing 4 does not contact the part of the rotor 12. In this case, the rotor 12 may also be driven to rotate at high speeds in the housing 4, causing a high speed air flow to be produced in the housing 4 in the direction in which the rotor 12 is rotating. This air flow causes the liquid refrigerant 20 to start to flow in the housing 4.

In the embodiment shown I FIG. 1, the outer yoke 10 has a hole 13a, 13b, 13c, 13d which extends through the outer yoke 10 in the radial direction thereof.

As the rotor 12 is driven to rotate, the liquid refrigerant 20 is allowed to flow toward the radially inner side of the outer yoke 10 through the hole 13a, 13b, 13c, 13d.

This enables the liquid refrigerant 20 to efficiently contact the cylindrical coil 8 located on the radially outer side of the yoke 10 and efficiently remove the heat from the cylindrical coil 8 being heated. The heat thus removed by the liquid refrigerant 20 is efficiently conducted to the housing 4 by the flow of the liquid refrigerant 20 contacting the inner wall surface of the housing 4.

By causing the rotor 12 to rotate at high speeds in the circumferential direction of the rotation center shaft 5, furthermore, the flow condition of the liquid refrigerant 20 in the housing 4 is further activated, and the gas-liquid mixed condition in the internal space of the housing 4 as described above is produced in the efficient way.

As described above, the liquid refrigerant 20 contained in the sealed housing 4 may contact or may not contact the part of the rotor 12. In either case, the internal space of the housing 4 is placed in the gas-liquid mixed condition by the high speed rotation of the rotor 12. As the rotor 12 has the hole 13a extending through it in the radial direction as described above, however, it can cause the gas-liquid mixed condition to be produced more efficiently and can cause the heat conduction from the cylindrical coi 18 being heated to the housing 4 to occur more efficiently.

In the embodiment shown in FIG. 1, the plurality of holesl 3a, 13b, 13c, 13d are formed and spaced away from each other at a specific interval in the circumferential direction of the cylindrical outer yoke 10 on its end side in FIG. 1, but the number and location of those holes are not limited to those in the embodiment shown in FIG. 1.

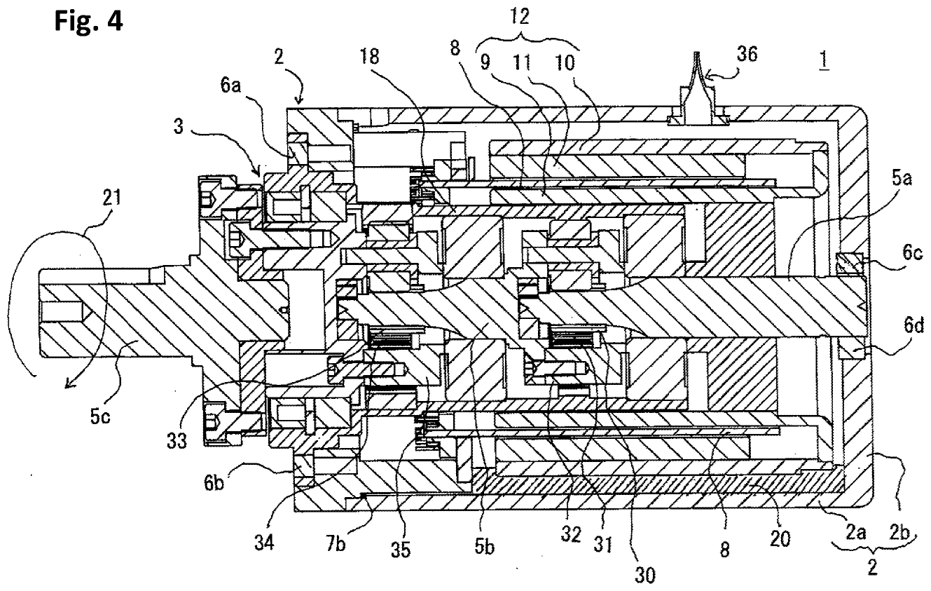

The structure in which the combination of the opening portion 14 and the plug 15 is used in this embodiment may be replaced by the structure in which the valve element 36 is employed in the variation of the embodiment to be described later as shown in FIG. 4. In this variation, the valve element 36 may be operated to allow the gas to be injected from the inside of the housing 4 to the outside of the housing 4 when the pressure exceeds a specific pressure level and the valve element 36 may be operated to allow the housing 4 to be sealed when the pressure drops below the specific pressure level.

The structure in which the housing 4 is sealed and closed hermetically can be the structure in which the sealed condition is retained and in which the rotor 12 that is driven to rotate allows the liquid refrigerant 20 contained in the housing 4 to flow in the housing 4, causing the liquid refrigerant 20 to contact the cylindrical coil 8 from which the heat is removed and permitting the heat thus removed to be conducted to the housing 4.

### Embodiment 2

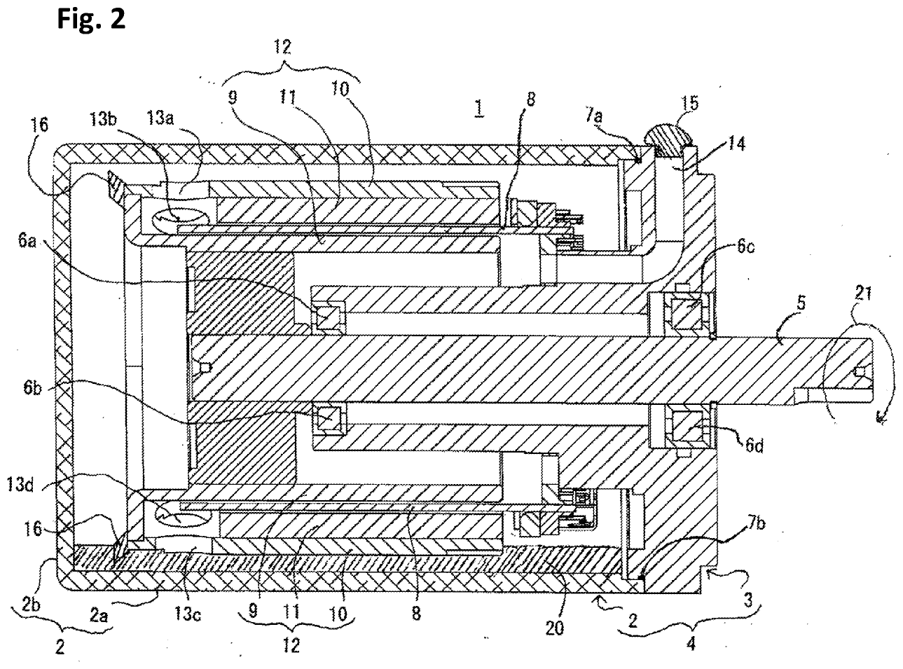

FIG. 2 is provided to illustrate one example of the embodiment in which the liquid refrigerant 20 contained in the sealed housing 4 is caused to flow more efficiently within the container 4 by the rotation of the rotor 12.

The rotor 12 has stirring blades 16, 16 extending toward the inner circumferential side surface of the cylindrical part 2a of the housing 4. Other structures are substantially the same as those of the embodiment shown in FIG. 1, and the parts that are common will be noted by the same reference numerals and the description of them will be omitted.

The rotor 12 having the stirring blades 16, 16 extending toward the inner circumferential side surface of the cylindrical part 2a of the housing 4 is allowed to rotate in the circumferential direction of the rotation center shaft 5, causing the liquid refrigerant 20 to flow more surely and more powerfully by the rotation of the rotor 12.

In the embodiment shown in FIG. 2, the stirring blades 16 and 16 extend from the radial outward of the rotor 12 and from the right end surface shown in FIG. 2 toward the radial outward directed toward the inner circumferential side of the cylindrical portion 2a of the housing 4 and toward the inner side of the disk-shaped portion 2b of the housing 4.

When the coreless motor 1 has the configuration shown in FIG. 2 in which the liquid refrigerant 20 is contained in the housing 4 as shown in FIG. 2 and although this is not shown, even when the coreless motor 1 has the configuration in which the disk-shaped portion 2b of the housing 4 is directed downwardly and the tip of the rotation center shaft 5 extending outwardly of the housing 4 is directed upwardly and the liquid refrigerant 20 contained in the housing 4 is located on the side of the disk-shaped portion 2b, the rotor 12 driven to rotate in the circumferential direction of the rotation center shaft 5 causes the liquid refrigerant 20 to flow in the housing 4 more securely and more powerfully.

### Embodiment 3

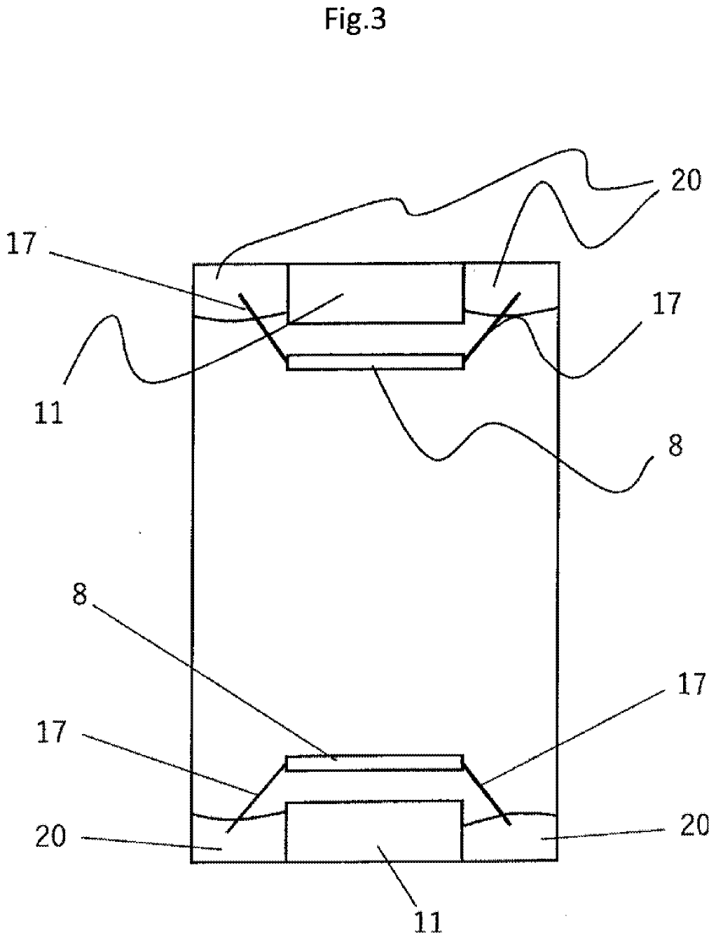

FIG. 3 is a conceptual diagram that is provided to illustrate another example of the embodiment in which the liquid refrigerant 20 contained in the housing 4 is caused to flow more efficiently by the rotation of the rotor 12.

The cylindrical portion 8 has a stirring projection 17 extending toward the radial outer side thereof.

As the rotor 12 is driven to rotate, the centrifugal force that is produced by the rotation of the rotor 12 may cause the liquid refrigerant 20 to be pressed against the radial outer side of the cylindrical coil 8 as shown in FIG. 3.

FIG. 3 shows that the magnet 11 is provided on the on the radial outer side of the outer yoke 10 and the liquid refrigerant 20 enters around the magnet 11 to form a liquid reservoir.

The stirring projection 17 extending from the cylindrical coil 8 toward the radial outer side is provided to protrude into the liquid reservoir, causing the liquid reservoir to be eliminated when the rotor 12 is driven to rotate. Thus, the liquid refrigerant 20 can flow more efficiently in the housing 4.

### Embodiment 4

In the embodiment shown in FIG. 1 and FIG. 2, the rotation center shaft 5 extends in the axial direction thereof at the center of the sealed housing 4 and is rotatably supported in the housing 4. In the embodiment shown in FIG. 4, the rotation center shaft 5 includes a first rotation center shaft 5a, a second rotation center shaft 5b and a third rotation center shaft 5c, all of which extend in the axial direction thereof (toward the right and left direction in FIG. 4).

In the embodiment shown in FIG. 4, furthermore, the disk-shaped lid portion 3 is rotatably attached to the right end opening of the cylindrical portion 2a included in the cylindrical casing 2 in FIG. 4 by means of bearings 6a, 6c, and the third rotation center shaft 5c is fixedly attached to the disk-shaper lid portion 3 so that it can be rotated together with the disk-shaped lid portion 3.

In the embodiment shown in FIGS. 1 and 2, the rotation center shaft 5 supports the rotor 12 on the radial inner side thereof so that the rotation center shaft 5 can be rotated directly by the rotation of the rotor 12. In the embodiment 4, however, a speed reducer including the planetary gears is provided in the housing 4 for transmitting the rotational motion of the rotor 12 rotating about the rotation center shaft 5 to the rotational motion output portion from which the different rotational motion of the rotation center shaft 5 is provided.

In the embodiment shown I FIGS. 1 and 2, the rotation center shaft 5 is provided as the rotation motion output section in the coreless motor 1 whereas in the embodiment shown in FIG. 4, the third rotation center shaft 5c is provided as the rotation motion output section in the coreless motor 1.

In the embodiment shown I FIGS. 1 and 2, the disk-shaped lid portion 3 has the opening 14 that may be sealed by the plug 15 and the plug 15 may be removed from the opening 14 to allow a specific amount of the liquid refrigerant 10 to be put into the housing 4. After then, the opening 14 may be sealed again by the plug 15 and the sealed condition of the housing 4 is thus retained.

In the embodiment shown in FIG. 4, however, the sealed housing has a valve element 36. In FIG. 4, the valve element 36 is provided in the cylindrical portion 2a of the housing 4. The valve element 36 is detachably provided in the cylindrical portion 2a. When the valve element 36 is removed from the cylindrical portion 2a, the refrigerant 20 is introduced into the housing 4. After then, the valve element 36 may be mounted on the cylindrical portion 2a as shown in FIG. 4 and the sealed condition of the housing 4 is thus retained.

The function of the valve element 36 is to prevent the liquid refrigerant 20 in the container 4 from leaking from the inside of the housing 4 to the outside of the housing 4. Structurally, the valve element 36 is operated to allow the liquid refrigerant 20 in the housing 4 to be ejected from the inside of the housing 4 to the outside of the housing 4 when the pressure in the housing 4 exceeds the specific pressure level and the valve element 36 is operated to seal the housing 4 again when the pressure drops below the specific pressure level. The sealed condition of the housing 4 is thus retained.

The other structures are basically the same as those described in the embodiments 1 and 2 in FIGS. 1 and 2. Those parts or elements which are common to those in the embodiments 1 and 2 are denoted by the same reference numerals as those in the embodiment in FIG. 4 and are not described.

A first sun gear 30 of the planetary gears included in the speed reducer is fixed to the tip (on the left side shown in FIG. 4) of the first rotation center shaft 5a supporting the radial inner side of the rotor 12 and rotatably supported by the disk-shaped portion 2b of the housing 4 on the right side in FIG. 4

As the rotor 12 is driven to rotate causing the first rotation center shaft 5a and the first sun gear 30 to rotate, this rotational motion is transmitted from the first sun gear 30 to the second rotation center shaft 5b through a first planetary gear 31 and a first carrier 32. The rotational motion thus transmitted causes the second rotation center shaft 5b to rotate in the same circumferential direction as the first rotation center shaft 5a.

A second sun gear 33 of the planetary gears included in the speed reducer is fixed to tip (on the left side in FIG. 4) of the second rotation center shaft 5b.

As the rotation of the second rotation center shaft 5b causes the second sun gear to rotate, this rotational motion is transmitted from the second sun gear 33 through the second planetary gear 34 and the second carrier 35 to the disk-shaped lid portion 3 supporting the third rotation center shaft 5c fixedly, causing the third rotation center shaft 5c to rotate in the same circumferential direction as the second rotation center shaft 5b (in the direction as indicated by an arrow 21, for example).

In this embodiment, the rotor 12 is also driven to rotate in the circumferential direction of the first rotation center shaft 5a by supplying the specific electric current to the cylindrical coil 8 under the condition in which the magnetic field is formed like the doughnut shape in cross section between the inner yoke 9 and the outer yoke 10. The radial inner side of the inner yoke 9 included in the rotor 12 is supported by the first rotation center shaft 5a. This also causes the rotation center shaft 5a to rotate in the circumferential direction thereof.

The rotational motion of the first rotation center shaft 5a is transmitted to the third rotation center shaft 5c through the planetary gears included in the speed reducer as described above, from which the output is provided.

In the embodiment shown in FIG. 4, the speed reducer described above is a two-stage speed reducer and the torque produced by the rotation of the rotor 12 can be increased by the two-stage speed reducer and the output is thus provided from the third rotation center shaft 5c.

The speed reducer having the structure described above is housed in the cylindrical gear case 18 extending in the direction in which the rotation center shaft, specifically the first rotation center shaft 5a, the second rotation center shaft 5b and the third rotation center shaft 5c extend.

The coreless motor 1 in the embodiment shown in FIG. 4 is also structured such that the liquid refrigerant 20 contained in the sealed housing 4 is enabled to flow in the housing by driving the rotor 12 to rotate in the circumferential direction of the first rotation center shaft 5a as described above.

In the embodiment show in FIG. 4, the liquid refrigerant 20 contained in the housing 4 is structured such that it has its liquid surface extending in the axial direction and making contact with the outer circumferential side surface of the outer yoke 10 in its stationary state.

Similarly to the embodiment in FIG. 4 that has been described above, as the rotor 12 is driven to rotate in the circumferential direction of the rotation center shaft 5, the rotor 12 causes the liquid refrigerant 20 contacting the outer circumferential side surface of the outer yoke 10 to flow in the circumferential direction in which the outer yoke 10 rotates as the outer yoke 10 rotates along the outer circumferential side surface. This also causes the liquid refrigerant 20 to rise in the circumferential direction along the outer circumferential side of the outer yoke 10. Then, the liquid refrigerant 20 that has risen in the circumferential direction along the outer circumferential side of the outer yoke 10 in the housing 4 falls down by its own weight along the outer circumferential side of the outer yoke 10 to the bottom side of the housing 4 placed in its horizontal state as shown in FIG. 1. As the liquid refrigerant 20 repeats the flow motion caused by the rotation of the rotor 12, it flows from the right and left end portions in FIG. 4 into the space formed between the inner side of the outer yoke 10 and the outer side of the cylindrical coil 8 and is made to contact the cylindrical coil 8 whose temperature begins to increase during the operation of the coreless motor 1.

By enabling part of the refrigerant 20 to contact the cylindrical coil 8 being heated, the cylindrical coil 8 is cooled. The heat of the cylindrical coil 8 being heated is removed by the liquid refrigerant 20 and is carried by the liquid refrigerant 20. The heat thus removed and carried by the liquid refrigerant 20 is conducted from the liquid refrigerant 20 to the housing 4 by causing the liquid refrigerant 20 to flow in the housing 4. This raises the temperature of the housing 4 from which the heat is dissipated from the entire outer side surface of the housing 4. In this way, the overheating of the cylindrical coil 8 that may be caused to occur during the operation of the coreless motor 1 is suppressed, and the coreless motor 1 can rotate at high speeds and produce the high power output by supplying the excessive electric current to the cylindrical coil 8.

By causing the liquid refrigerant 20 to flow in this manner, part of the liquid refrigerant 20 can flow into the cylindrical gear case 18. By using the oil that lubricates the mechanical parts or elements as the liquid refrigerant 20, each of the planetary gears included in the speed reducer can be lubricated.

Like the embodiments 1 and 2, the gas-liquid mixed condition is created in the internal space of the housing 4 as described above by driving the rotor 12 to rotate at high speeds in the circumferential direction of the rotation center shaft 5. The heat of the cylindrical coil 8 being heated by conducting the electric current through the cylindrical coil 8 is conducted from the cylindrical coil 8 to the housing 4 more efficiently. Thus, the overheating of the cylindrical coil 8 that may be caused to occur during the operation of the coreless motor 1 is suppressed, and therefore the coreless motor 1 can be allowed to rotate at high speeds by supplying the excessive current to the cylindrical coil 8.

In this embodiment, the valve element 36 having the above-described function is provided in the housing 4. For example, therefore, when the coreless motor 1 can be operated to rotate at high speeds during the long time period during which the pressure in the housing 4 exceeds the specific pressure level, the gas will be ejected from the inside of the housing 4 to the outside of the housing 4. This allows the coreless motor 1 to be operated to rotate at high speeds during the long time period during which the pressure in the housing 4 can also exceed the allowable pressure level. When that situation occurs, the valve element 36 is operated to eject the gas from the housing 4. The pressure in the housing 4 can thus be prevented from exceeding the allowable pressure level.

In this embodiment, the speed reducer that includes the planetary gears as described above is provided in the housing 4 so that the rotational motion of the rotor 12 rotating about the rotation center shaft can be transmitted to the rotational motion output section from which a different rotational motion of the third rotation center shaft 5c is provided.

The oil that is used for lubricating the mechanical parts or elements as the liquid refrigerant 20 is intended to lubricate each of the planetary gears included in the speed reducer.

In the embodiment shown in FIG. 4, the speed reducer including the planetary gears that are lubricated by the oil can be provided in the housing 4, and any sounds or noises that may be produced by those gears rotating or meshing with each other can be suppressed. Thus, the coreless motor 1 can be operated quietly. The presence of the oil having the moderate viscosity ensures that the gears included in the speed reducer can be rotating quietly.

It should be noted that the plurality of gears included in the speed reducer may produce any metal powders due to the metal wear during the rotation the gears. The metal powders thus produced may be mixed into the oil that is used as the liquid refrigerant 20, causing the oil to become contaminated or dirty.

The rotor 12 includes the magnet 11 as described above and the metal powders are attracted by the magnet 11, preventing the oil from becoming contaminated or dirty by those meal powders.

Each of the planetary gears included in the speed reducer may be made of any synthetic resin or stainless steel. As such, the water may be used as the refrigerant or cooling medium to prevent those gears from becoming rusted. When the oil is used as the refrigerant, it may prevent the gears from becoming rusted even if they are made of iron, but in order to prevent the gears from becoming rusted by using the water as the refrigerant, a rust inhibitor may be added to the water that is used as the refrigerant or the so-called reduced water (electrolytic water) may be used. When the speed reducer including the planetary gears is made of any synthetic resin in this case, the problem in which the gears may produce the metal powders due to the metal wear during the rotation of the gears as described above can be avoided.

Usually, the grease is used for the motor, but a high viscosity material such as the grease may be subjected to a centrifugal force as the motor is rotating and may be moved away from the point at which the grease is applied. In the present invention, the oil is used instead of the grease. Thus, the grease is not required. Generally, the oil that is used for lubricating the gears in the speed reducer may become liquefied at 80° C., and the effect of using the grease cannot be obtained. For this reason, it is usual that the grease should be prevented from becoming the temperature of 80° C. if the grease is used for lubricating the gears.

In the coreless motor in this embodiment, the temperature of the cylindrical coil 8 that is heated by conducting the electric current through the cylindrical coil 8 is generally higher than 80° C. For this reason, the use of the grease is not recommended.

It should also be noted that the embodiment in which the valve element 36 is used may be replaced by the embodiment 1 in which the housing 4 is closed hermetically by the combination of the opening portion 14 and the plug 15 as described above.

### Embodiment 5

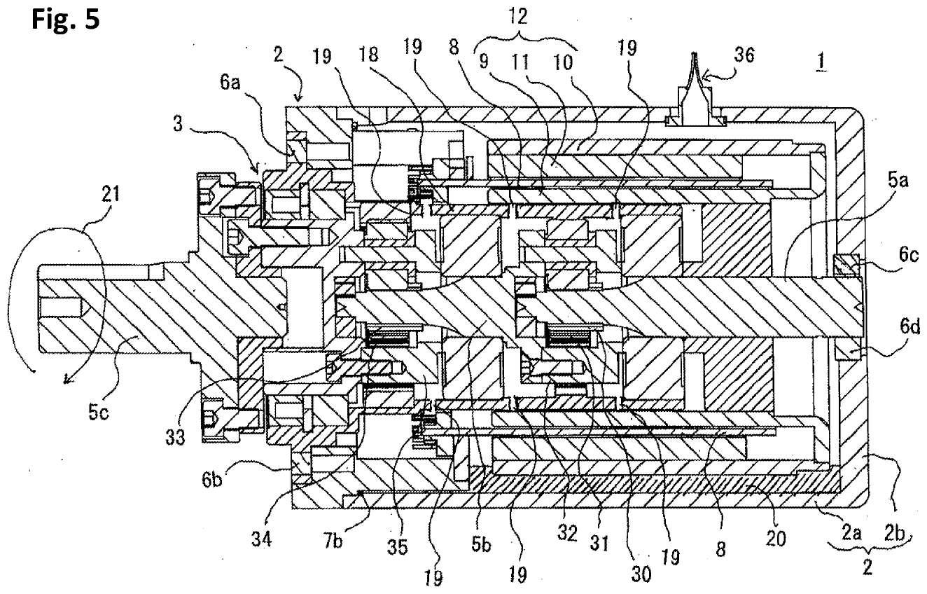

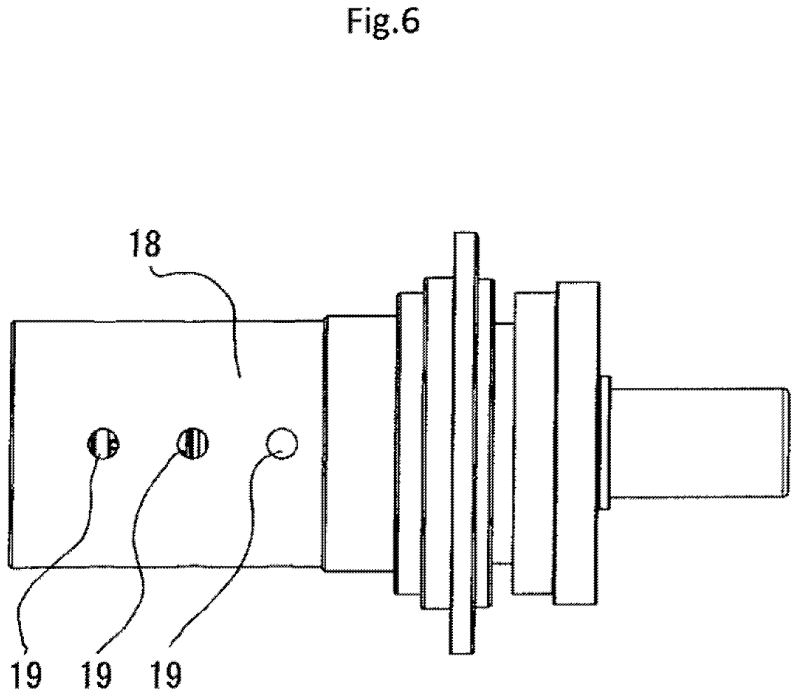

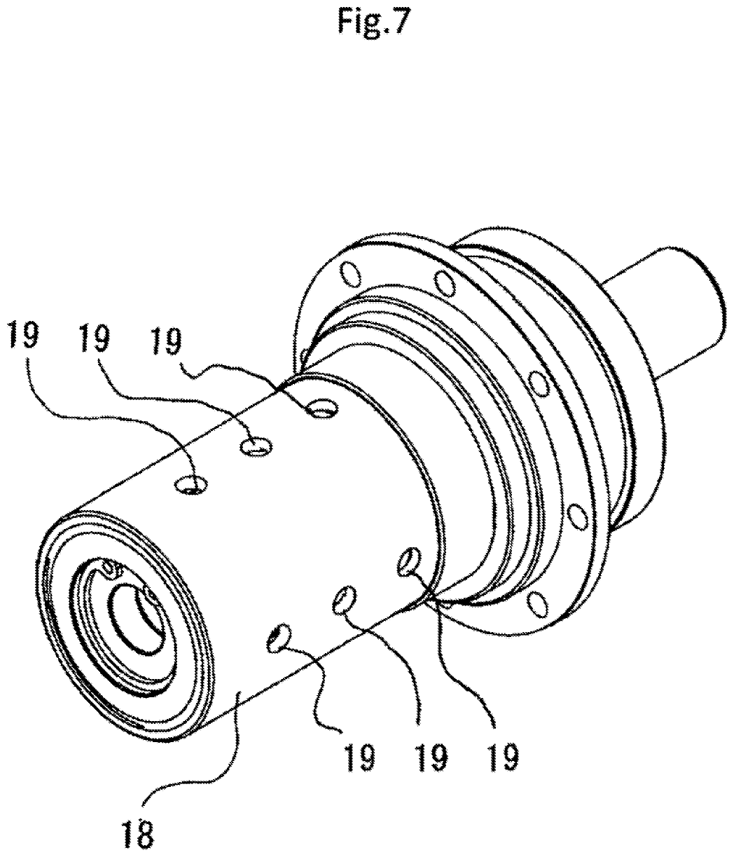

The FIG. 5 to FIG. 7 are provided to illustrate the variation of the embodiment 4 (FIG. 4). In the embodiment 4 (FIG. 4), it is described above that the speed reducer is housed in the cylindrical gear case 18 that extends in the direction in which the rotation center shaft, specifically the first rotation center shaft 5a, the second rotation center shaft 5b and the third rotation shaft 5c extend.

In the varied embodiment 5 shown in FIGS. 5 to 7, the gear case 18 has a hole 19 extending through the gear case 18 in the radial direction thereof.

It is apparent from the above description that as the rotor 12 is driven to rotate in the circumferential direction of the first rotation center shaft 5a, the liquid refrigerant 20 contained in the sealed housing 4 is caused to flow in the housing 4. By allowing part of the liquid refrigerant 20 flowing in to housing 4 to contact the cylindrical coil 8 being heated, the heat of the cylindrical coil 8 becomes vaporized. The gas-liquid mixed condition is thus created in the internal space of the housing 4, and the heat of the cylindrical coil 8 being heated by conducting the electric current through the cylindrical coil 8 is conducted efficiently from the cylindrical coil 8 to the housing 4.

At the same time, it is intended that the liquid refrigerant 20 flowing in the housing 4 is also used for lubricating each of the planetary gears included in the speed reducer.

In the varied embodiment shown in FIGS. 5 to 7, the cylindrical case 18 in which the speed reducer is housed has a hole 19 passing through the gear case 18 in the radial direction thereof, through which the liquid refrigerant 20 can be supplied efficiently to the cylindrical coil 8. Thus, each of the gears can be lubricated more efficiently by the liquid refrigerant 20.

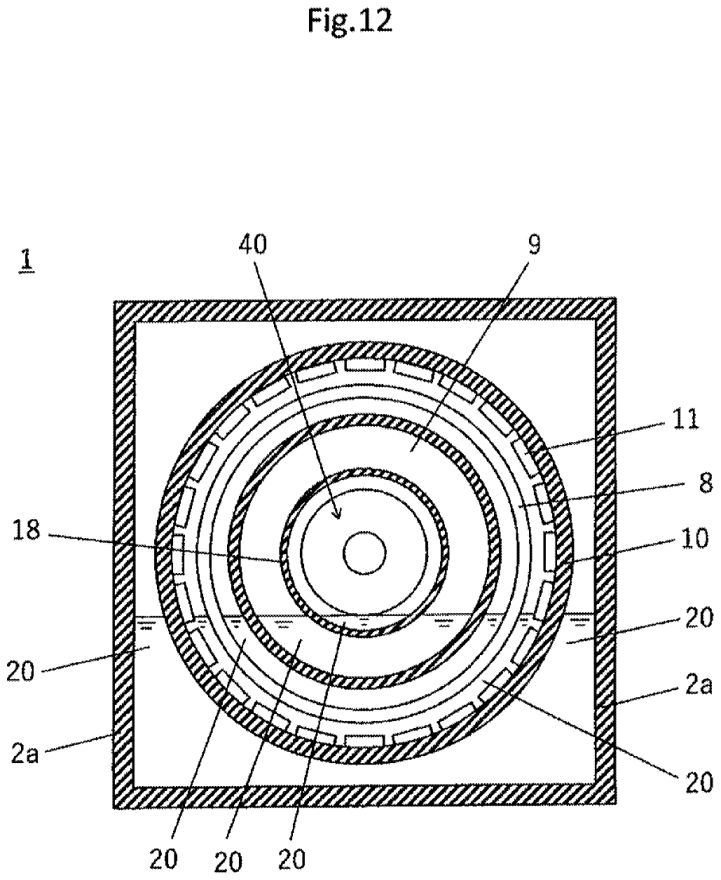

It should also be noted that as shown in FIG. 12, the liquid surface of the liquid refrigerant 20 extending in the axial direction thereof in its stationary state can be brought into contact with the outermost circumferential edge of the planetary gears 40 in the radial direction thereof.

In the manner described above, the liquid refrigerant 20 is supplied to the speed reducer immediately when the rotor 12 starts to rotate so that each of the gears can be lubricated more efficiently by the liquid refrigerant 20.

In the varied embodiment shown in FIGS. 5 to 7, a plurality of holes 19 are formed at the specific regular intervals in the circumferential direction of the cylindrical gear case 18 and at the specific regular intervals in the longitudinal direction of the cylindrical gear case 18.

The number and location of the holes 19 may be determined optionally.

### Embodiment 6

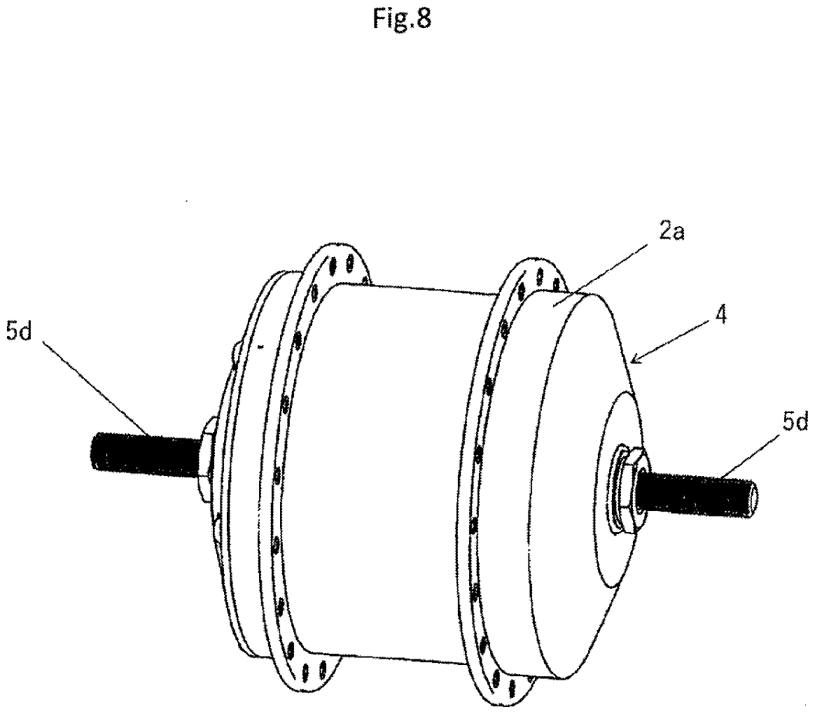

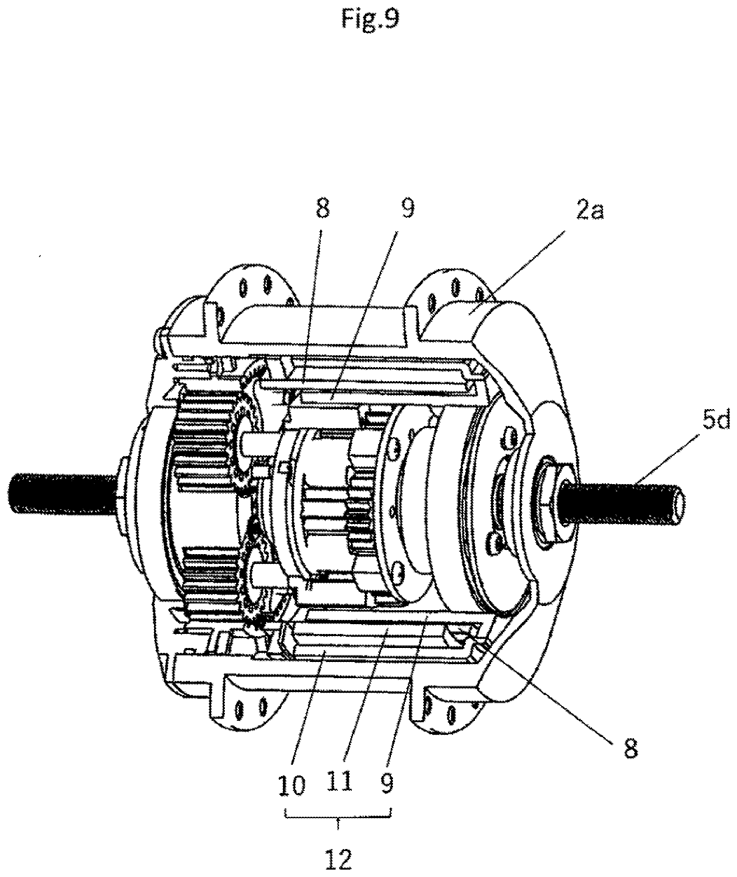

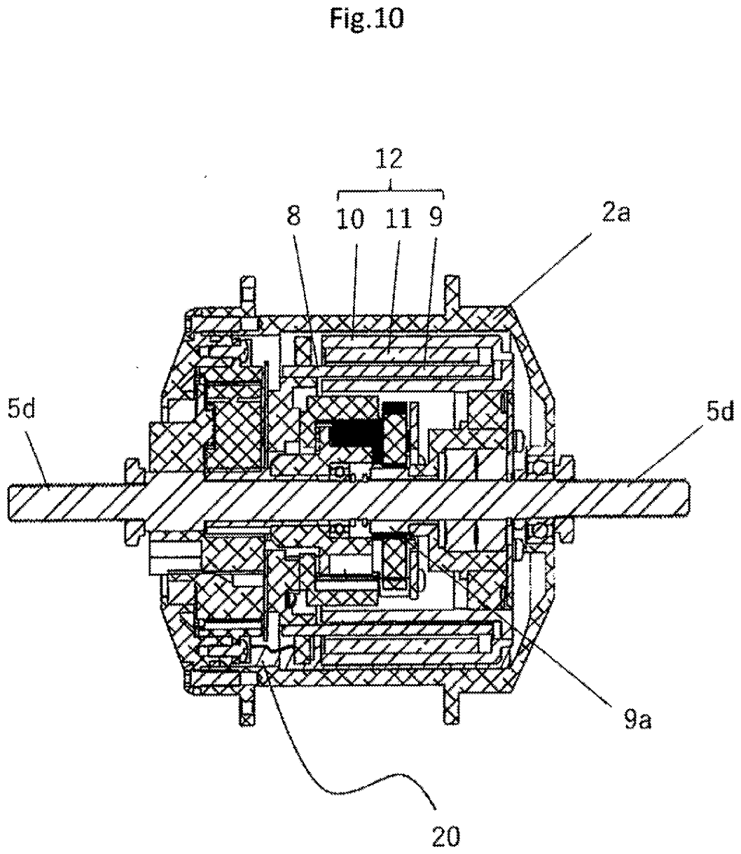

FIGS. 8 to 10 are provided to illustrate another variation of the embodiment 4.

It should be noted that in the varied embodiment in FIGS. 8 to 10, the structure in which the housing 4 is sealed by the combination of the opening portion 14 and the plug 15 and the structure in which the housing 4 is sealed by the valve elements 36 are not shown specifically because they have been described and shown in the embodiment 1 and in the embodiment 4.

In the embodiment 4 (FIG. 4), the rotation center shaft including the first rotation center shaft 5a, the second rotation center shaft 5b and the third rotation center shaft 5c further includes the fixed shaft 5d that extends through the housing 4. The housing 4 that is internally sealed is rotatably supported by the fixed shaft 5d through the oil seal. The cylindrical portion 2a that forms part of the housing 4 serves as the rotational motion output section.

In the varied embodiment shown in FIGS. 8 to 10, the inner yoke included in the rotor 12 is rotatably supported on its radial center side by the fixed shaft 5d. Then, the outer circumference 9a of the radial center side of the inner yoke rotatably supported by the fixed shaft 5d acts as the first sun gear in the embodiment 4 (FIG. 4).

In the embodiment 4 (FIG. 4), the rotational motion of the first sun gear that rotates together with the first rotation center shaft is transmitted through the first planetary gear, the first carrier, the second sun gear, second planetary gear and the third carrier to the third rotational motion output section, from which a different rotational motion of the third rotation output shaft is provided.

In the varied embodiment shown in FIGS. 8 to 10, the rotational motion of the first sun gear formed by the outer circumference of the radial center portion 9a of the inner yoke rotatably supported by the fixed shaft 5d is supported through the first planetary and the first carrier and then through the second sun gear, the second planetary gear and the third carrier rotatably supported by the fixed shaft 5d to the rotational motion output section from which a different rotational motion of the cylindrical portion 2d forming part of the housing 4 that occurs in the circumferential direction around the fixed shaft 5d.

The other parts or elements are basically the same as those in the embodiment 4 (FIG. 4).

In this embodiment, the liquid refrigerant 20 contained in the sealed housing 4 is also caused to flow by driving the rotor 12 to rotate in the circumferential direction of the fixed shaft 5d. This creates the gas-liquid mixed condition in the internal space of the housing 4 and the heat of the cylindrical coil 8 being heated by conducting the electric current through the cylindrical coil 8 is conducted efficiently from the cylindrical coil 8 to the housing 4. Thus, the overheating of the cylindrical coil 8 that may be caused to occur during the operation of the coreless motor 1 is suppressed, ensuring that the coreless motor 1 can rotate at high speeds and provide the high power output by supplying the excessive current to the cylindrical coil 8. This sequence is the same as that in the embodiments 1 and 2.

The oil may be used as the liquid refrigerant 20 to lubricate the mechanical parts or elements. It is intended that by using the oil, each of the planetary gears included in the speed reducer can be lubricated and the speed reducer that includes the planetary gears can thus be provided in the housing 4. The sound or noise that may be produced by causing the gears to rotate or mesh with other can thus be prevented, allowing the coreless motor 1 to rotate quietly.

### (Test Case)

Tests were conducted using the coreless motor offered by the inventor of the present patent application to the commercial market. Typically and structurally, this coreless motor includes the cylindrical coil disposed concentrically with respect to the rotation center shaft in the housing with the end surface on one side of the cylindrical coil being supported by the stator and extending in the direction in which the rotation center shaft extends, and the rotor disposed concentrically with respect to the rotation center shaft in the housing and capable of rotation in the circumferential direction of the rotation center shaft.

Two units of the coreless motor (CPH80F) were tested, both of which were closed hermetically. One of the units used the water as the liquid refrigerant and the other unit did not use the water as the liquid refrigerant and was operated as usual.

Those two units were operated simultaneously in the same room under the same conditions of the input of 24 volts dc, the torque of 1 Nm and the output of 380 W. The results of those tests are presented in Table 1 (the embodiments in which the liquid refrigerant (water) was used) and Table 2 (the comparative case in which the liquid refrigerant (water) was not used).

TABLE 1
The embodiment (the liquid refrigerant (water) was used)

| Time | | | | | | | | | Outside |
|---|---|---|---|---|---|---|---|---|---|
| Elapsed | | Number of | | | | | Temp of | Temp | Temp(Room |
| (minuts) | Torque | rotations | Current | Input | Output | Efficiency | Housing | of Coil | Temp) |
| 0 | 1.00 | 3542 | 21.5 | 515 | 372 | 72.3 | 23.4 | 35.8 | 23.7 |
| 5 | 1.02 | 3561 | 21.8 | 523 | 379 | 72.4 | 57.3 | 61.4 | 24.4 |
| 10 | 1.01 | 3588 | 21.9 | 525 | 381 | 72.5 | 68.7 | 73.5 | 24.3 |
| 30 | 1.02 | 3643 | 21.8 | 525 | 388 | 74.0 | 88.8 | 98.0 | 26.4 |

TABLE 2
The comparative case (the liquid refrigerant (water) was not used)

| Time | | | | | | | | | Outside |
|---|---|---|---|---|---|---|---|---|---|
| Elapsed | | Number of | | | | | Temp of | Temp | Temp(Room |
| (minuts) | Torque | rotations | Current | Input | Output | Efficiency | Housing | of Coil | Temp) |
| 0 | 1.00 | 3600 | 20.0 | 485 | 377 | 77.7 | 23.5 | 36.6 | 23.7 |
| 5 | 0.98 | 3616 | 19.7 | 477 | 371 | 77.9 | 35.1 | 56.2 | 24.4 |
| 10 | 1.00 | 3615 | 20.1 | 488 | 377 | 77.2 | 45.9 | 77.4 | 24.3 |
| 15 | 1.00 | 3630 | 20.5 | 495 | 380 | 76.7 | 54.1 | 95.4 | 24.7 |

It is apparent from the test results that liquid refrigerant contained in the sealed housing is caused to flow in the housing by the rotation of the rotor and is brought into contact the cylindrical coil being heated, causing part of the liquid refrigerant to become vaporized so that the gas-liquid mixed condition can be created in the housing. It is thereby confirmed that the heat in the housing can be conducted with the greater efficiency, and the temperature of the housing can also be increased following the temperature of the cylindrical coil that is increased. In this way, the heating of the housing can be dissipated with the greater efficiency.

### (Embodiment of Power Generator)

Although the coreless motor has been described with reference to its several embodiments or variations thereof, it is not limited to those embodiments or variations thereof. The structure and capabilities of the motor are substantially the same as those of the power generator. In the structure and capabilities of the coreless motor described above, the power can be produced by the input rotational motion caused by the rotation of the rotor. The power generator can be operated similarly to the coreless motor. In the present invention, therefore, the power generator having the structures and capabilities that are equivalent to those of the above described coreless motor can be embodied.

Although the present invention has been described with reference to several embodiments thereof, it should be understood that it is not limited to those embodiments and it can be modified in various ways or manners without departing from the spirit and scope of the invention as defined in the claims.

1. A coreless motor which comprises:
a rotation center shaft extending in the axial direction thereof at the center of a sealed housing;
a cylindrical coil disposed concentrically with respect to said rotation center shaft in said housing with an end surface on one side of said cylindrical coil being supported by a stator and extending in the direction in which said rotation center shaft extends;
a rotor disposed concentrically with respect to said rotation center shaft and capable of rotation in the circumferential direction of said rotation center shaft, said rotor including a cylindrical inner yoke and a cylindrical outer yoke sandwiching said cylindrical coil therebetween in the radial direction and having a magnet provided on the outer side of said inner yoke or on the inner side of said outer yoke; and
a liquid refrigerant contained in said housing, said liquid refrigerant having its liquid surface extending in said axial direction in its stationary state and contacting the outer circumferential side of said outer yoke, whereby said liquid refrigerant is caused by the rotation of said rotor to flow inside said housing and contact said cylindrical coil.

2. The coreless motor as defined in claim 1, wherein said outer yoke has a hole passing through said outer yoke in the radial direction thereof.

3. A coreless motor which comprises:
a rotation center shaft extending in the axial direction thereof at the center of a sealed housing;
a cylindrical coil disposed concentrically with respect to said rotation center shaft in said housing with an end surface on one side of said cylindrical coil being supported by a stator and extending in the direction in which said rotation center shaft extends;
a rotor disposed concentrically with respect to said rotation center shaft and capable of rotation in the circumferential direction of said rotation center shaft, said rotor including a cylindrical inner yoke and a cylindrical outer yoke sandwiching said cylindrical coil therebetween in the radial direction and having a magnet provided on the outer side of said inner yoke or on the inner side of said outer yoke;
a speed reduction gear disposed in said housing and including planetary gears for transmitting the rotational movement of said rotor around said rotation center shaft to a rotational movement output section from which a different rotational movement is produced; and
a liquid refrigerant contained in said housing, said liquid refrigerant having its liquid surface extending in said axial direction in its non-rotational state and contacting the outer circumferential side of said outer yoke, whereby said liquid refrigerant is caused by the rotation of said rotor to flow inside said housing and contact said cylindrical coil.

4. The coreless motor as defined in claim 3, wherein said speed reduction gear is contained in a cylindrical gear case extending in the direction in which said rotation center shaft extends, said gear case having a hole passing through said gear case in the radial direction.

5. The coreless motor as defined in claim 3, wherein the liquid surface of said liquid refrigerant extending in said axial direction in its stationary state contacts the outermost circumferential edge of said planetary gears in the radial direction thereof.
